(19) United States
(12) Patent Application Publication
(10) Pub. No.: US 2004/0020339 A1
(43) Pub. Date: Feb. 5, 2004

(54) Machine for the multiple cutting-off of rolls of kitchen and/or toilet paper from logs

(76) Inventor: Giovanni Gambini, Pisa (IT)

Correspondence Address: James V. Costigan, Esq., Hedman & Costigan, P.C., Suite 2003, 1185 Avenue of the Americas, New York, NY, 10036-2646, US

(21) Appl. No.: 10/628,672

(22) Filed: Jul. 28, 2003

(30) Foreign Application Priority Data
Jul. 30, 2002 (IT) MI2002A 001704

(51) Int. Cl. B26F 3/00

(52) U.S. Cl. 83/177; 83/53

(57) ABSTRACT

A machine for the multiple cutting-off of rolls of kitchen and/or toilet paper from logs which comprises a bed (18) onto which at least two logs (15) are fed through a respective conveyor with thrusters (12) towards a cutting head (20), wherein the conveyor with thrusters (12) passes below the cutting head (20) which comprises a cutting device using high-pressure water (21, 22, 23) which acts transversally on at least two logs (15) separating an equal number of finished rolls (10) of a predetermined length.

In particular, the cutting device using high-pressure water is mounted on an oscillating or rotating arm which acts transversally to the logs.

The present invention refers to a machine for the multiple cutting-off of rolls of kitchen and/or toilet paper from logs.

In the field of the production of rolls of kitchen and/or toilet paper starting from wound rods or logs of a predetermined diameter and a certain height, for example about two meters, and known as “logs”, they must be cut so as to realise single rolls, for example about 200 mm in length, ready to be distributed.

Currently, the cutting to the predetermined size of these final rolls is carried out on suitable cutting-off machines which receive, for example, the single log and cut it in succession into a plurality of rolls, each of the required size. Indeed, the log, once its winding is complete, goes onto a conveyor with thrusters through which it is sent below the cutting-off machine.

Usually, this machine comprises a motorised cutting disc carried on an arm. The arm is made to rotate to pass from a position disengaged from one or two underlying logs, advanced on the conveyor, to an engaged position to cut one or more rolls. Such an operation is repeated for the whole length of the initial log and thus for all of the other logs which advance.

This type of machine thus foresees cutting discs, or blades, which wear down and then must be replaced with the machine shut down.

Moreover, it must be kept in mind that each cutting disc engages on a limited number of logs to be cut into rolls, at most four underlying logs, given the circular trajectories which the disc can follow.

Furthermore, the use of discs means that in a certain number of logs arranged next to each other the central logs are engaged more by the cutting blade. This means a non-uniform cut and generates an overheating of the blade since the thickness of the cutting blade grows towards the centre.

In order to try to accelerate the cutting operations cutting-off machines have been realised which indeed follow the log(s) as they advance on the conveyor with thrusters and cut them in movement in an attempt to save time.

In any case, the use of discs in these machines involves the presence of devices which are particularly complex and which must be perfectly adjusted so as not to realise rolls cut to different sizes or not perfectly cut according to the requirements of users. Moreover, they have the same problems as the aforementioned devices.

The purpose of the present invention is that of realising a machine for the multiple cutting-off of rolls of kitchen and/or toilet paper from logs which solves the problems indicated previously.

Another purpose is that of realising a machine for the multiple cutting-off of rolls of kitchen and/or toilet paper from logs which is extremely simple and functional, whilst still allowing the cutting work to proceed at a good speed with high productivity.

Another purpose is that of realising a machine for the multiple cutting-off of rolls of kitchen and/or toilet paper from logs which avoids the use of discs given their wear and the connected problems.

Another general purpose is that of realising a machine for the multiple cutting-off of rolls of kitchen and/or toilet paper from logs which brings cost savings and interruptions reduced to the minimum.

These and other purposes according to the present invention are accomplished by realising a machine for the multiple cutting-off of rolls of kitchen and/or toilet paper from logs as outlined in claim 1.

Additional characteristics are foreseen in the dependent claims.

The characteristics and advantages of a machine for the multiple cutting-off of rolls of kitchen and/or toilet paper from logs according to the present invention shall become clearer from the following description, given as an example and not for limiting purposes, referring to the attached schematic drawings, in which:

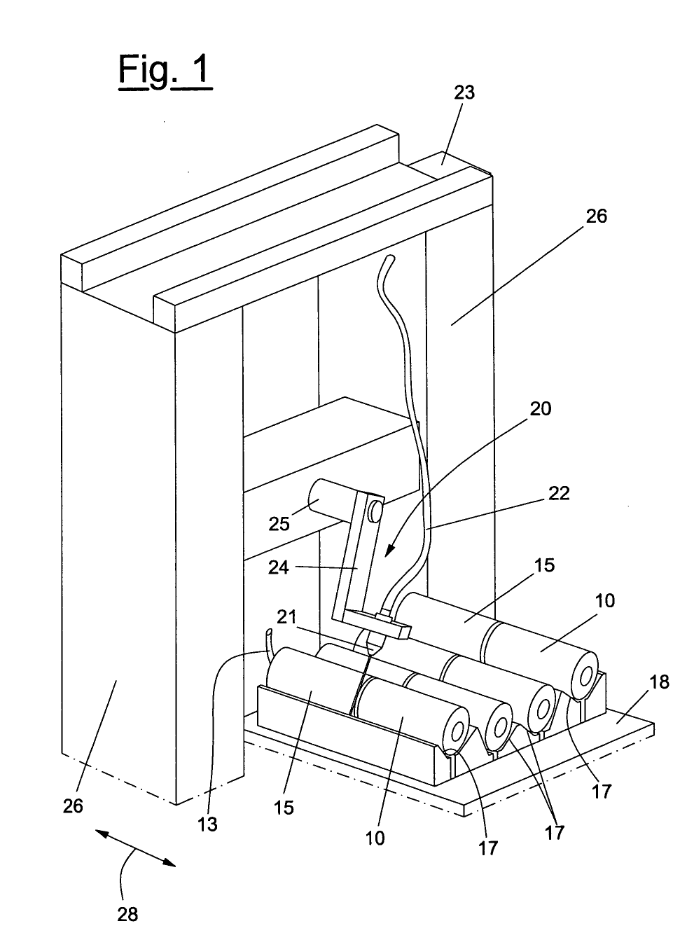

FIG. 1 is a perspective view of a machine for the multiple cutting-off of rolls of kitchen and/or toilet paper from logs according to the present invention;

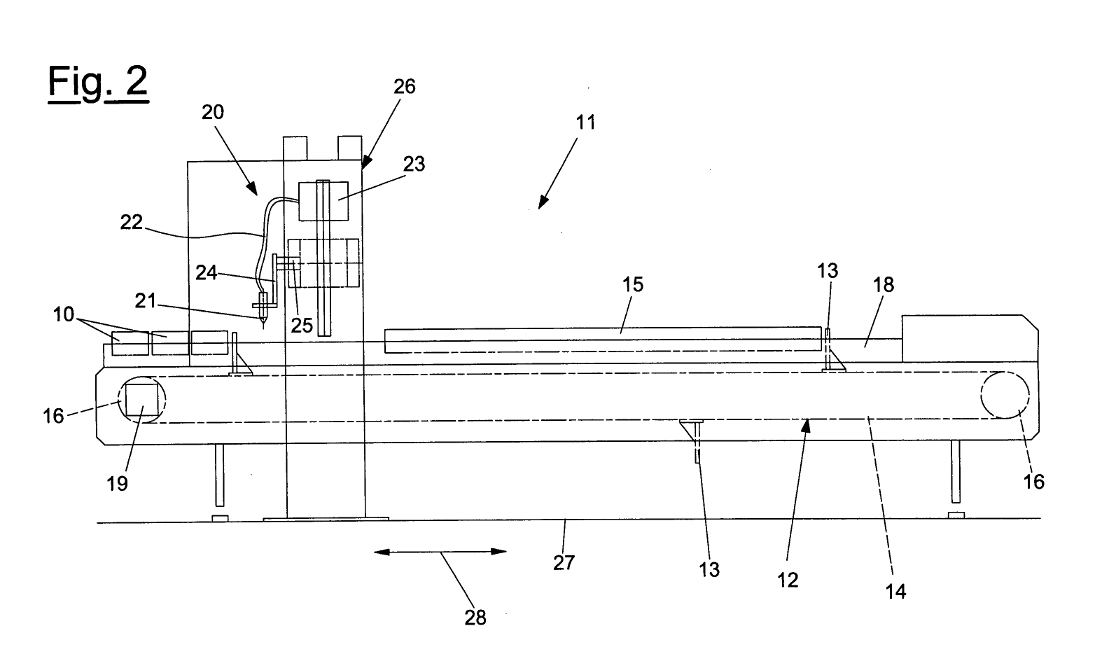

FIG. 2 is a side elevation view of the machine of FIG. 1; and

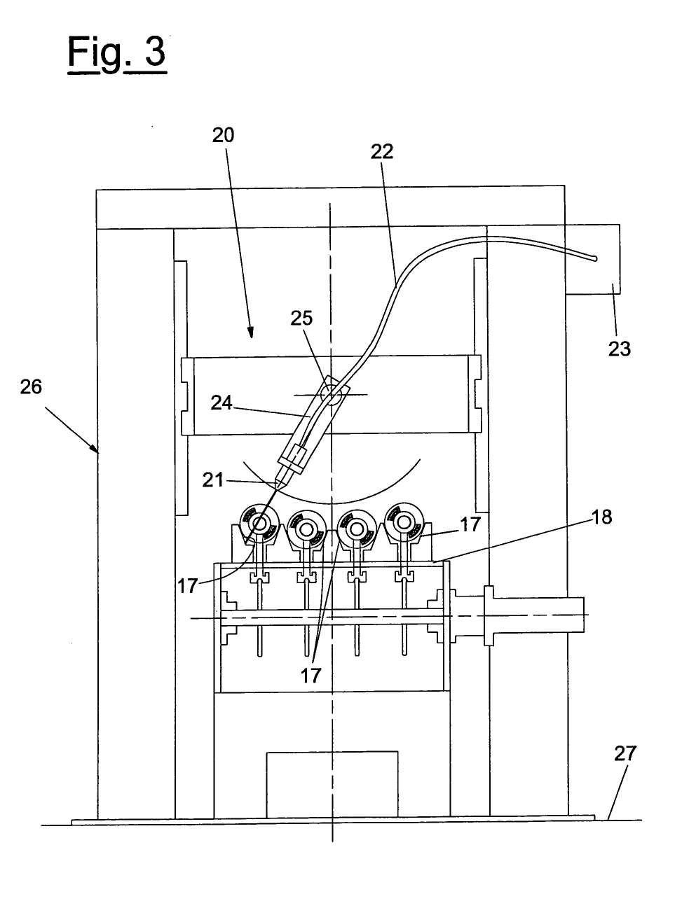

FIG. 3 is a cross-section of the machine in the cutting area.

With reference to the figures, a machine for the multiple cutting-off of rolls of kitchen and/or toilet paper from logs according to the present invention is shown, wholly indicated with 11.

The cutting-off machine 11 is arranged downstream of a conveyor with thrusters 12 which feeds a series of at least two logs 15, through individual thrusters 13, carried by a chain 14 closed into a ring around end pulleys 16, to be cut to the predetermined size in a series of rolls 10 (in the example the logs 15 are four in number).

Moreover, in the example the conveyor 12 is a conveyor with four channels 17 arranged on a bed 18 and is activated by a motor 19 (a stepper motor or at least one which can be actuated to determine advancing in a number of steps which can be predetermined or even continuously). In general, the motor is a stepper motor actuated according to steps equivalent to a predetermined length of finished rolls 10.

Suitable gripping elements (not shown) hold the logs 15 and engage on them when they have been advanced by the predetermined step below the cutting-off machine 11.

This cutting-off machine 11 comprises a cutting head 20 which comprises a cutting nozzle 21 connected through a duct 22 to a high-pressure water source, schematised at 23.

The cutting nozzle 21 is arranged on an arm 24 rotating and oscillating around a pin 25 arranged on the structure carrying the cutting head 20.

Such a structure carrying the cutting head 20 can be raised and/or lowered with respect to the conveyor with thrusters 12 carrying the logs 15 to keep a distance which is always equal during the cutting thereof. The cutting thus takes place transversally to the underlying logs 15.

The cutting head 20 can be arranged on a portal structure 26, which can be displaced forwards and backwards along guides 27 according to the double-pointed arrow 28.

In such a way the portal structure 26 can be displaced forwards and/or backwards parallel to the conveyor with thrusters 12 actuated continuously.

It is clear that to complete the machine systems for detecting the logs can be foreseen to determine the predetermined length of the finished rolls 10 which are thus obtained.

The advantage of a cutting-off machine according to the present invention substantially consists of the fact that it operates without interruption thanks to the presence of a cutting head using high-pressure water.

Moreover, the cutting nozzle eliminates the presence of discs or blades which may be dangerous in the work environment and avoids any problem of heating by sharpening of the blades and possible fires.

The cutting is perfect without problems of compactness of the roll and without any problem of wear of the cutting tool.

The shut down time is drastically reduced or even eliminated and concentrated with general cleaning or format change times.

Each maintenance intervention is limited to the presence of the nozzle which can quickly be replaced and checked thereafter.

Harmful deposits connected to the metal of the discs or the sharpening thereof are totally eliminated.

In such a way the management costs are drastically reduced with the elimination of the discs and of the grinding wheels for the grinding thereof.

With this machine cutting according to many channels is also realised for various logs simultaneously, with increased productivity.

Such an operation could also involve the arrangement of a nozzle on the piston of an actuator which can be displaced transversally to the logs with greater speed and precision.

A cutting/off machine according to the present invention thus solves all of the problems of the prior art and allows logs to be manipulated simply and reliably by cutting rolls of whatever diameter in whatever number without any problem, allowing high productivity.

1. Machine for the multiple cutting-off of rolls of kitchen and/or toilet paper from logs which comprises a bed (18) onto which at least two logs (15) are fed through a respective conveyor with thrusters (12) towards a cutting head (20), characterised in that said conveyor with thrusters (12) passes below said cutting head (20) which comprises a cutting device using high-pressure water (21, 22, 23) which acts transversally on said at least two logs (15) separating an equal number of finished rolls (10) of a predetermined length.

2. Machine according to claim 1, characterised in that said cutting device using high-pressure water (21, 22, 23) is mounted on a portal structure (26) which can be displaced forwards and/or backwards with respect to said bed (18).

3. Machine according to claim 2, characterised in that said portal structure (26) carries said cutting device using high-pressure water (20) comprising a cutting nozzle (21) connected through a duct (22) to a high-pressure water source (23).

4. Machine according to claim 1, characterised in that said cutting device using high-pressure water (20) comprises a cutting nozzle (21) arranged on an arm (24) rotating or oscillating around a pin (25) arranged on a portal structure (26).

5. Machine according to claim 1, characterised in that said conveyor with thrusters (12) is actuated by a stepper motor (19) according to steps equivalent to the predetermined length of finished rolls (10).

6. Machine according to claim 1, characterised in that said at least two logs (15) are arranged in channels (17) in which thrusters (13) of said conveyor (12) are inserted.
